(19) United States
(12) Patent Application Publication
(10) Pub. No.: US 2026/0140956 A1
(43) Pub. Date: May 21, 2026

(54) METHOD AND APPARATUS FOR SUPPORTING MULTIPLE VECTOR SEARCH USING SIMILARITY-BASED SEARCH SCHEDULING

(71) Applicant: D.notitia.Inc., Seongnam-si (KR)

(72) Inventor: Young Il KIM, Seoul (KR)

(73) Assignee: D.notitia.Inc., Seongnam-si (KR)

(21) Appl. No.: 19/393,781

(22) Filed: Nov. 19, 2025

(30) Foreign Application Priority Data
Nov. 20, 2024 (KR) 10-2024-0166320

(51) Int. Cl. G06F 16/2457; G06F 16/2453

(52) U.S. Cl. CPC G06F 16/24575; G06F 16/24532

(57) ABSTRACT

Disclosed is a method for processing multiple vector searches including receiving, by an apparatus executing a vector index host, a search task set including a plurality of search tasks, associatively performing, by the apparatus executing the vector index host, a similarity-based search scheduling task based on similarity between the plurality of search tasks included in the search task set, performing, by the apparatus executing the vector index host, a search request by delivering, in an order of the similarity-based search scheduling task, a query vector corresponding to each search task to an apparatus executing a vector search, and delivering, by the apparatus executing the vector search, a search result for the search request to the apparatus executing the vector index host. Representative drawing is FIG. 8.

### CROSS-REFERENCE TO RELATED APPLICATIONS

This application claims priority under 35 U.S.C. § 119 to Korean Patent Application No. 10-2024-0166320 filed on Nov. 20, 2024, in the Korean Intellectual Property Office, the disclosures of which are incorporated by reference herein in their entireties.

### BACKGROUND

### 1. Field of the Disclosure

Embodiments of the present disclosure described herein relate to a method of providing multiple vector searches, which efficiently performs data caching by using similarity-based search scheduling during nearest neighbor searches in a vector database environment, and an apparatus therefor.

### 2. Discussion of Related Art

Nowadays, as the number of companies seeking to apply generative artificial intelligence to their internal systems increases, technologies supporting the more effective use of a Large Language Model (LLM) are being developed. Technical architecture that constitutes the LLM, such as development frameworks (e.g., LangChain and LlamaIndex), in-context learning, and a vector database (DB), are attracting attention. In particular, the vector DB stores unstructured data such as tables, graphs, images, videos, and audio, and allows unlabeled content to be found.

Vector search in the vector DB refers to a task of finding vectors most similar to a given query vector among vectors stored in the database. To this end, a vector database system may convert data (text, images, etc.) to be found into a fixed-length dense vector by using pre-trained models and may index the converted vectors in a vector database for an efficient search.

In the case, various approximate nearest neighbor search techniques may be used. Unlike traditional key-value searches, the vector search is based on semantic similarity, thereby enabling flexible and meaningful searches. Nowadays, vector search technologies have been advancing in various fields, including semantic search using large language models and integrated search of multi-modal data (text, images, audio, etc.).

In the meantime, conventional vector search technologies based on a nearest neighbor search have limitations in that vector search requires significant time and computing resources because a vector access pattern according to a search request is performed randomly. In particular, when a plurality of search requests are processed, this randomness may lead to significant time and computing resources required for each search.

There is a prior art disclosed as Korean Patent Publication No. 2023-0077251 (Publication date: Jun. 1, 2023).

### SUMMARY

Embodiments of the present disclosure provide a method of scheduling search tasks such that search operations with high access vector similarity are capable of being performed as sequentially as possible, thereby improving a cache hit ratio. Embodiments of the present disclosure provide a method of reducing memory access time by reusing information stored in a cache when processing multiple query vectors sequentially through it, thereby improving the execution speed of a task.

Embodiments of the present disclosure provide a method for efficiently utilizing hardware resources of a vector database system by reducing the idle time of a hardware engine that processes vector searches. Embodiments of the present disclosure provide a method for increasing hardware resource utilization by removing the dependency on a vector database host of the vector search hardware.

Problems to be solved by the present disclosure are not limited to the above-described problems, and other problems not mentioned herein may be clearly understood from this specification and the accompanying drawings by those skilled in the art to which the present disclosure pertains.

According to an embodiment, a method for processing multiple vector searches using similarity-based search scheduling in a vector search system includes receiving, by an apparatus executing a vector index host, a search task set including a plurality of search tasks, associatively performing, by the apparatus executing the vector index host, a similarity-based search scheduling task based on similarity between the plurality of search tasks included in the search task set, performing, by the apparatus executing the vector index host, a search request by delivering, in an order of the similarity-based search scheduling task, a query vector corresponding to each of the plurality of search tasks to an apparatus executing a vector search, and delivering, by the apparatus executing the vector search, a search result for the search request to the apparatus executing the vector index host.

In an embodiment, the performing of the similarity-based search scheduling task includes generating a plurality of query vectors respectively corresponding to the plurality of search tasks, determining similarity between the plurality of query vectors, and setting search scheduling such that similarity between consecutive query vectors in a search scheduling order is set to be higher than similarity between non-consecutive query vectors in the search scheduling order, based on the similarity between the plurality of query vectors.

In an embodiment, the search task set may be pieces of image information related to a plurality of scenes generated by capturing a video at a regular interval. Moreover, the performing of the similarity-based search scheduling task may include grouping the pieces of image information based on an object in the video and setting a search schedule by setting the pieces of image information, which are grouped with a same object, as a single similarity group.

In an embodiment, the performing of the search request by delivering the query vector corresponding to each of the plurality of search tasks to the apparatus executing the vector search may include delivering, by the apparatus executing the vector index host, each query corresponding to each search task to the apparatus for executing the vector search in an order of the similarity-based search scheduling task, and creating, by the apparatus executing the vector index host, a candidate node list for searching for the respective query with respect to the query.

In an embodiment, the performing of the search request by delivering the query vector corresponding to each of the plurality of search tasks to the apparatus executing the vector search may further include checking, by the apparatus executing the vector index host, a multi-search count, selecting at least one search target node from the candidate node list, and delivering a search request for a neighboring node of the node to the apparatus for executing the vector search.

In an embodiment, the performing of the search request by delivering the query vector corresponding to each of the plurality of search tasks to the apparatus executing the vector search may include delivering, by the apparatus executing the vector index host, a first search request for searching for similarity with the query with respect to a neighboring node of a first node of the candidate node list for searching for an arbitrary query, and delivering, by the apparatus executing the vector index host, a second search request for searching for similarity with the query with respect to a neighboring node of a second node of the candidate node list without waiting for a response to the first search request.

According to an embodiment, a vector search system that supports multiple vector searches includes an apparatus executing a vector index host that receives a search task set including a plurality of search tasks, associatively performs a similarity-based search scheduling task based on similarity between the plurality of search tasks included in the search task set, and performs a search request by delivering, in an order of the similarity-based search scheduling task, a query vector corresponding to each search task to an apparatus executing a vector search, and the apparatus executing the vector search that delivers a search result for the search request to the apparatus executing the vector index host.

In an embodiment, the apparatus executing the vector index host may generate a plurality of query vectors respectively corresponding to the plurality of search tasks, determine similarity between the plurality of query vectors, and set search scheduling such that similarity between consecutive query vectors in a search scheduling order is set to be higher than similarity between non-consecutive query vectors in the search scheduling order, based on the similarity between the plurality of query vectors.

In an embodiment, the search task set may be pieces of image information related to a plurality of scenes generated by capturing a video at a regular interval. Moreover, the apparatus executing the vector index host may group the pieces of image information based on an object in the video and set a search schedule by setting the pieces of image information, which are grouped with a same object, as a single similarity group.

According to an embodiment, a non-transitory computer-readable storage medium may store computer-readable instructions. When executed by a computer apparatus, the instructions cause the computer apparatus to receive a search task set including a plurality of search tasks, associatively perform a similarity-based search scheduling task based on similarity between the plurality of search tasks included in the search task set, and perform a search request by delivering, in an order of the similarity-based search scheduling task, each query vector corresponding to each search task to an apparatus executing a vector search.

Solutions to the problem of the present disclosure are not limited to the above-described solution, and solutions not mentioned herein may be clearly understood from this specification and the accompanying drawings by those skilled in the art to which the present disclosure pertains.

### BRIEF DESCRIPTION OF THE FIGURES

The above and other objects and features of the present disclosure will become apparent by describing in detail embodiments thereof with reference to the accompanying drawings.

FIG. 1 is a flowchart for describing a process, in which a user processes and searches for data by using a vector DB system, according to an embodiment of the present disclosure.

FIG. 2 is a block diagram for describing a structure of vector search-dedicated hardware in a vector DB system, according to an embodiment of the present disclosure.

FIG. 3 is a diagram for describing a query search method and a vector index structure generated according to an embodiment of the present disclosure.

FIG. 4 is a diagram for describing the dependency on a vector index host of a vector search processing engine in a vector database system.

FIG. 5 is a diagram for describing a method for requesting a plurality of vector search requests in a vector database system, according to an embodiment of the present disclosure.

FIG. 6 is a diagram for describing a method for requesting vector searches for a plurality of queries in a vector database system, according to an embodiment of the present disclosure.

FIG. 7 is a flowchart illustrating a method for processing multiple vector searches in a vector database system, according to an embodiment of the present disclosure.

FIG. 8 is a diagram illustrating a search processing order according to search scheduling, according to an embodiment of the present disclosure.

FIG. 9 is a drawing for describing a structure of a vector database system in which dependency on a vector index host of a vector search processing engine occurs.

FIG. 10 is a diagram for describing a structure of a vector database system that processes a plurality of vector search request, according to an embodiment of the present disclosure.

FIG. 11 is a diagram for describing a structure of a vector database system that processes a vector search request for a plurality of queries, according to an embodiment of the present disclosure.

FIG. 12 is a flowchart illustrating an embodiment of a similarity-based search scheduling task, which is set based on similarity between search tasks, according to an embodiment of the present disclosure.

FIG. 13 is a flowchart illustrating an embodiment of a similarity-based search scheduling task, which is set based on similarity between search tasks, according to another embodiment of the present disclosure.

FIG. 14 is a diagram for describing a computing operating environment of a vector index host, according to one embodiment of the present disclosure.

### DETAILED DESCRIPTION

Hereinafter, with reference to the drawings, embodiments of the present disclosure will be described in detail so that those skilled in the art can easily implement the present disclosure.

However, the present disclosure may be implemented in various different forms and is not limited to the embodiments described herein. In relation to the description of the drawings, the same or similar reference numerals may be used for the same or similar components. In addition, in the drawings and related descriptions, descriptions of well-known functions and configurations may be omitted for clarity and conciseness.

Various embodiments of this disclosure and terms used therein are not intended to limit the technical features described in this disclosure to specific embodiments, and should be understood to include various modifications, equivalents, or alternatives of the embodiments. In relation to the description of the drawings, similar reference numerals may be used for similar or related components. The singular form of a noun corresponding to an item may include one item or a plurality of items, unless the relevant context clearly dictates otherwise. In this disclosure, phrases such as “A or B,” “at least one of A and B,” “at least one of A or B,” “A, B or C,” “at least one of A, B and C,” and “at least one of A, B, or C” may include any one of the items listed together in the corresponding phrase among those phrases, or all possible combinations of the items. Terms such as “first,” “second,” or “firstly,” “secondly” may simply be used to distinguish a corresponding component from other corresponding components, and unless specifically stated to the contrary, do not limit the corresponding components in other respects (e.g., importance or order). In this disclosure, if a certain (e.g., first) element is referred to as being “linked,” “combined,” “accessed,” “connected,” or “coupled” with or without the terms “functionally” or “communicatively” to another (e.g., second) component, it means that the certain component can be connected to the other component directly (e.g., in a wired manner), wirelessly, or through a third component.

The term “module” used in various embodiments of this document may include a unit implemented as hardware, software, or firmware and may be interchangeably used with a term such as “logic,” “logical block,” “part,” or “circuit.” The module may be an integrated part, or a minimum unit of the part or a part thereof, which performs one or more functions. For example, according to an embodiment, the module may be implemented in the form of an application-specific integrated circuit (ASIC).

Various embodiments of this document may be implemented as software (for example, a program) including one or more commands stored in a storage medium that may be read by a machine or device. For example, a processor of the machine or device may call at least one command among one or more commands stored in the storage medium, and may execute the command. This enables the machine to be operated to perform at least one function according to at least one called command. The one or more commands may include a code generated by a compiler or a code executable by an interpreter. The machine-readable storage medium may be provided in the form of a non-transitory storage medium. Here, “non-temporary” only means that the storage medium is a tangible device and does not include a signal, and this term does not discriminate a case where data is stored semi-permanently in the storage medium and a case where data is temporarily stored therein.

According to one embodiment, the method according to various embodiments disclosed in this document may be included and provided in a computer program product. The computer program product may be traded as a product between a seller and a purchaser. The computer program product may be distributed in the form of a device-readable storage medium (for example, a compact disc read only memory (CD-ROM)), or may be directly distributed (for example, downloaded or uploaded) online through an application store or between two user devices (for example, smartphones). In the case of online distribution, at least some of the computer program products may be temporarily stored or temporarily generated in a device-readable storage medium such as a memory of a manufacturer's server, an application store server, or a relay server.

According to various embodiments, each component (for example, module or program) of the components described above may include a singular object or a plurality of objects. According to various embodiments, one or more components or operations among the aforementioned components may be omitted, or one or more other components or operations may be added. Alternatively or additionally, a plurality of components (for example, modules or programs) may be integrated into a single component. In this case, the integrated component may perform one or more functions of each of the plurality of components identically or similarly to those performed by the corresponding component of the plurality of components prior to the integration. According to various embodiments, operations performed by modules, programs, or other components are executed sequentially, in parallel, iteratively, or heuristically, or one or more of the operations are executed in a different order or omitted, or one or more other operations may be added.

The processor in the present disclosure may be hardware capable of performing functions and operations according to each name described in the present specification, may be computer program code capable of performing specific functions and operations, or may be an electronic recording medium loaded with computer program code capable of performing specific functions and operations. The processor may be a functional and/or structural combination of hardware for performing the technical idea of the present disclosure and/or software for driving the hardware.

A large language model (hereinafter referred to as “LLM”) in the present disclosure may be a language model capable of performing a natural language processing (NLP) task.

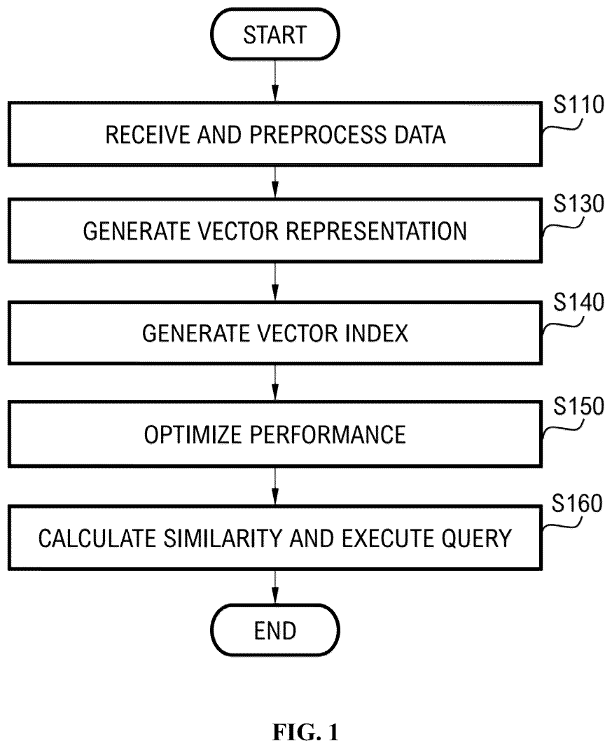

FIG. 1 is a flowchart for describing a process, in which a user processes and searches for data by using a vector DB system, according to an embodiment of the present disclosure.

In operation S110 of FIG. 1, a vector DB system may receive data from a user. The data may include both structured data and unstructured data. The vector DB system may assign a tenant for the user and may refine the data by performing duplication removal, normalization, and cleansing.

In operation S130 of FIG. 1, the vector DB system may generate and store a vector representation of the received data by using an embedding model. Vector embedding may be defined as representing unstructured data and/or structured data such as text, images, voice, tables, and graphs, in a multi-dimensional vector space by reflecting data characteristics. This enables the measurement of semantic similarity among data. The vector embedding may be performed in various ways, and the present disclosure should not be interpreted as limited to any specific method. For example, the vector representation may be extracted through an embedding model provided by the vector DB system. In another example, the vector representation may be extracted from an external embedding model linked to the vector DB system, not the embedding model provided by the vector DB system.

In operation S140 of FIG. 1, the vector DB system may generate and store an index for the vector representation of the data. The vector index is a data structure for quickly performing a similarity search between vectors. The vector index may be applied to a structure that hashes similar vectors into the same bucket, and a structure that hierarchically connects vectors with high similarity as a graph-based structure.

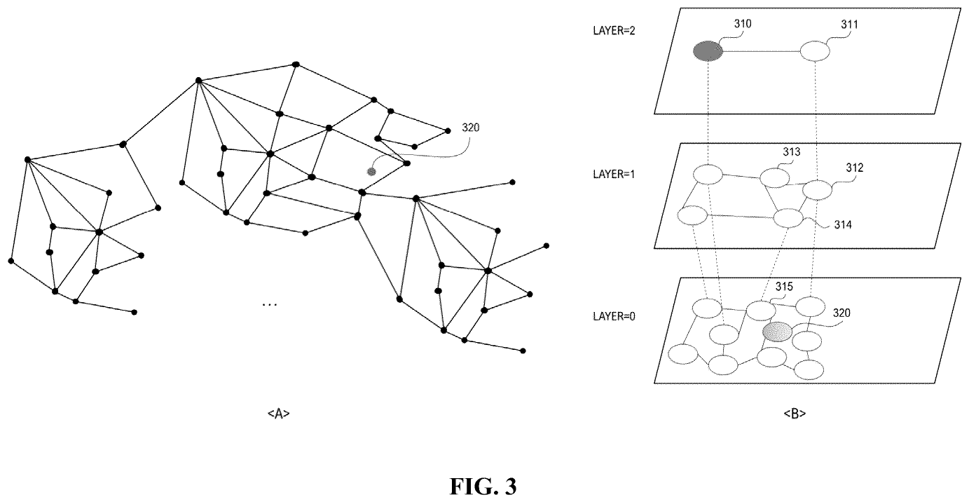

For example, a vector DB according to an embodiment of the present disclosure may generate a vector index by using a graph including a node representing a feature value of a data point in enterprise data and an edge representing the relationship between a plurality of nodes. In the case, the graph may be formed to have a hierarchical structure. For example, the hierarchical structure may be formed by forming a plurality of layers, forming all nodes in the bottom layer, and forming fewer nodes as it goes to an upper layer. The vector index structure according to an embodiment of the present disclosure will be described later in the descriptions of the attached FIG. 3.

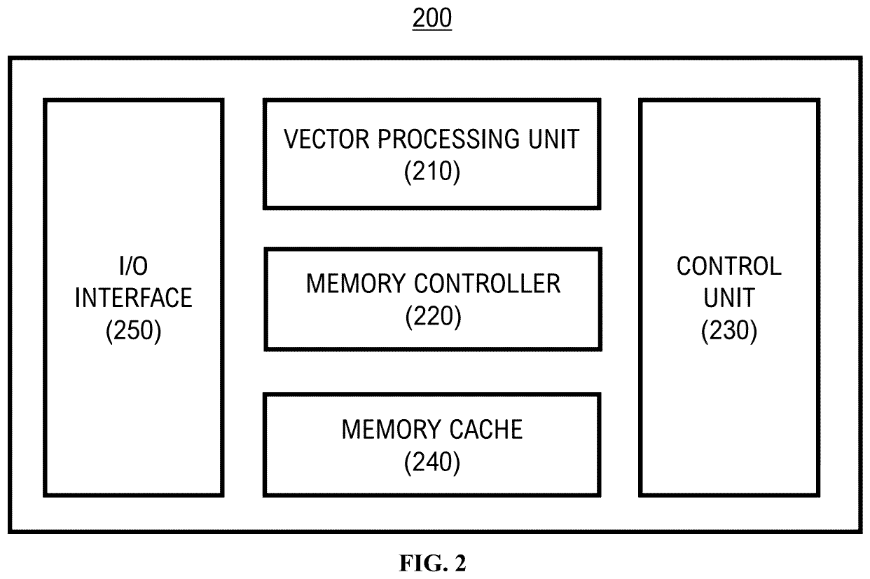

In the meantime, in operation S150 of FIG. 1, the vector DB system may perform performance optimization to efficiently search for stored vector data and vector indexes. For example, the vector DB system may include vector search-dedicated hardware to reduce CPU usage and to shorten a search time by processing large-scale vector operations in parallel. The vector DB system may efficiently perform distributed storage, clustering, and caching as well as parallel processing of vector data by using the vector search-dedicated hardware, thereby improving overall system efficiency. The structure of the vector search-dedicated hardware according to an embodiment of the present disclosure will be described later in the description of the attached FIG. 2.

In operation S160 of FIG. 1, when a query of a user is received, the vector DB system may express the query as a vector value by applying the query to the vector embedding model, may calculate a vector index for a query vector, and may search for and return vectors with high similarity. Cosine similarity or Euclidean distance may be used to calculate similarity between vectors.

For example, a method of comparing a query vector with all data points to calculate respective distances, and generating a candidate dataset sorted by proximity may be considered as a vector search method. This method is highly accurate but slow. Accordingly, a nearest neighbor search may be considered to provide a balance between search speed and search quality. In the vector DB, a nearest neighbor search algorithm is used to quickly find a neighboring vector close to a query vector in high-dimensional data. The method of calculating the similarity between the query vector and all data points has high accuracy but has a slow search speed. Accordingly, the nearest neighbor search algorithm may provide the compromise between accuracy and speed in vector search. The nearest neighbor search according to an embodiment of the present disclosure will be described below with reference to the attached FIG. 3.

Afterwards, the vector DB system may return the query results and may complete the process. In the case, the vector DB system may output the results to a user interface and may further perform result filtering and sorting operations.

FIG. 2 is a block diagram for describing a structure of vector search-dedicated hardware in a vector DB system, according to an embodiment of the present disclosure.

A vector search-dedicated hardware 200 according to an embodiment of the present disclosure is designed to process vector operations at high speed and to maximize the efficiency of a vector similarity search. The vector search-dedicated hardware 200 may include a vector processing unit 210, a memory controller 220, a control unit 230, a memory cache 240, and an I/O interface 250.

The vector processing unit 210 of FIG. 2 may perform high-speed calculations on large amounts of vector data through parallel processing. Vector calculations for a similarity search between a query vector and a DB vector are designed to calculate a distance such as cosine similarity distance and Euclidean distance. The vector processing unit 210 corresponds to a module optimized for high-dimensional vector operations.

The memory controller 220 of FIG. 2 may store vector data in storage and may manage memory access for reading vector data stored in the storage. The memory controller 220 features a high-bandwidth memory interface to minimize data transfer bottlenecks occurring during operations and to optimize computation speed.

The control unit 230 of FIG. 2 may control an operation of the vector search-dedicated hardware 200. The control unit 230 may schedule vector search tasks and may manage workflows between the vector processing unit 210, the memory controller 220, and the I/O interface 250. In more detail, the control unit 230 adjusts task priorities and ensures the stability and efficiency of the system.

The memory cache 240 of FIG. 2 may temporarily store frequently used vector data to increase memory access speed. The memory cache 240 minimizes data access latency through a multilevel cache (e.g., L1 cache, L2 cache, etc.) and supports fast access to data repeatedly referenced during calculations.

The I/O interface 250 of FIG. 2 may process data input/output between an external data source and hardware. The I/O interface 250 supports various interfaces, such as Peripheral Component Interconnect Express (PCIe) and Ethernet, for high-speed data transmission and processes large-scale vector data in real time to integrate the processed result with a database.

The vector search-dedicated hardware 200 illustrated in FIG. 2 is a dedicated hardware configuration designed to optimize vector operations by providing a high-performance and high-efficiency vector data processing environment, thereby effectively increasing the efficiency of vector data processing and maximizing similarity search performance.

FIG. 3 is a diagram for describing a query search method and a vector index structure generated according to an embodiment of the present disclosure.

As illustrated in FIG. 3, a vector index structure according to an embodiment of the present disclosure may be represented as a graph including a node representing a characteristic value of a data point and an edge representing relationships between a plurality of nodes. In the case, a graph may be formed as a planar structure, as illustrated of FIG. 3A, or may be formed as a hierarchical structure, as illustrated of FIG. 3B.

When a vector index according to an embodiment of the present disclosure is formed in a hierarchical structure, as shown in layer 0 of FIG. 3B, layer 0 being a bottom layer may include all nodes for data points and be configured by connecting only similar nodes with a horizontal edge. Furthermore, as shown in layer 1 of FIG. 3B, layer 1 being an upper layer of layer 0 may be formed by probabilistically extracting some nodes from layer 0 and connecting similar nodes among the extracted nodes with a horizontal edge. Likewise, layer 2 being an upper layer of layer 1 may be formed by probabilistically extracting some nodes from layer 1 and connecting similar nodes among the extracted nodes with a horizontal edge. The vector index structure according to an embodiment of the present disclosure may be formed to have a hierarchical structure by extracting fewer nodes as it goes to an upper layer and connecting nodes in a lower layer with similar relationships to nodes in an upper layer by using a vertical edge.

Meanwhile, when a query vector 320 is input as in examples of FIG. 3A or 3B, according to an embodiment of the present disclosure, nodes similar to the query vector 320 may be quickly found by using a vector index of FIG. 3A or a vector index of FIG. 3B. In more detail, when operations are repeated to move to a node closest to a start node by calculating a distance between the start node and each of its neighboring nodes, starting from the start node, and to move to a node closest to the corresponding node by calculating a distance between the corresponding node and each of its neighboring nodes based on the moved node, a node closest to the query vector 320 may be found quickly.

In the case, when the vector index has a hierarchical structure, as shown in FIG. 3B, a search begins at a start node 310 of layer 2 being a top layer, and then moves to a node 311 closest to the query node 320. Next, when being incapable of getting closer to the query node 320 from the node 311, it may move to a node 312 of layer 1 being a lower layer of layer 2 connected to the node 311. Next, it moves from the node 312 to a node 314 that is close to the query node 320. Next, when being incapable of getting closer to the query node 320 from the node 314, it may move to a node 315 of layer 0 being a lower layer of layer 1 connected to the node 314. The node 315 closest to the query node 320 may be quickly found by repeating this process until the closest node to the query node 320 is reached.

This search method is known as an Approximate Nearest Neighbor (ANN) index search, which enables an efficient search of the nearest data in high-dimensional data. In the ANN index search, vector similarity may be typically calculated by using an angle-based cosine similarity algorithm or a Euclidean distance-based Euclidean similarity algorithm.

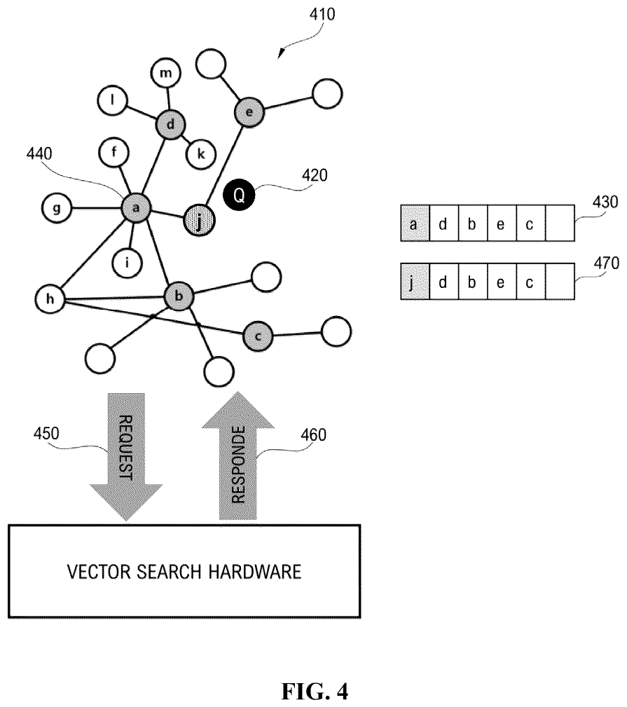

FIG. 4 is a diagram for describing dependency of a vector search processing engine on a vector index host in a vector database system. In the database system, the vector index host is a software system component running on a central processing unit (CPU) that processes an operation of an ANN algorithm, and the vector search hardware is a hardware device that accelerates vector and matrix operations and may be called dedicated hardware or an offloading engine that is in charge of vector calculation in the vector database system.

A vector index structure such as 410 may be considered. When a query such as 420 is input to a vector index structure such as 410, the vector index host may create a candidate node list as nodes a, d, b, e, c for a query vector as in 430.

The candidate node list 430 may be a list of nodes for calculating the similarity between the query vector and the neighboring node, and the size and update conditions of the candidate node list may be set in advance.

For example, when the candidate node list is a, d, b, e, and c as in 430, the vector index host may request the vector search hardware to search for the query 420 for f, g, h, i, and j, which are neighbor nodes of node a with the highest priority as in 450.

In this case, the vector search hardware may receive the request to start the vector search and return the vector search result to the vector index host as in 460. Thereafter, the vector index host may update the candidate node list by referring to the response from the vector search hardware.

For example, when the vector search result is 8 for node f, 12 for node g, 15 for node h, 7 for node i, and 2 for node j, the vector index host will update the candidate node list as in 470 by recording the node j with the shortest distance to the query 420 at the very front of the candidate node list.

Thereafter, the vector index host may request the vector search hardware to search for the query 420 for e, which is a neighbor node of node j with the highest priority in the updated candidate node list.

For example, vector search hardware may only begin a vector search when receiving a new request. That is, in this example, after returning a response 460 to a request 450, the vector search hardware has a period of idle time until a new request for the next vector search arrives. The reason is that a vector index host receives a response from the vector search hardware, updates a candidate node list, and then delivers the next search request to the vector search hardware. In this example, an operation of the vector search hardware has dependency on the vector index host, thereby resulting in idle time during the execution of a search task.

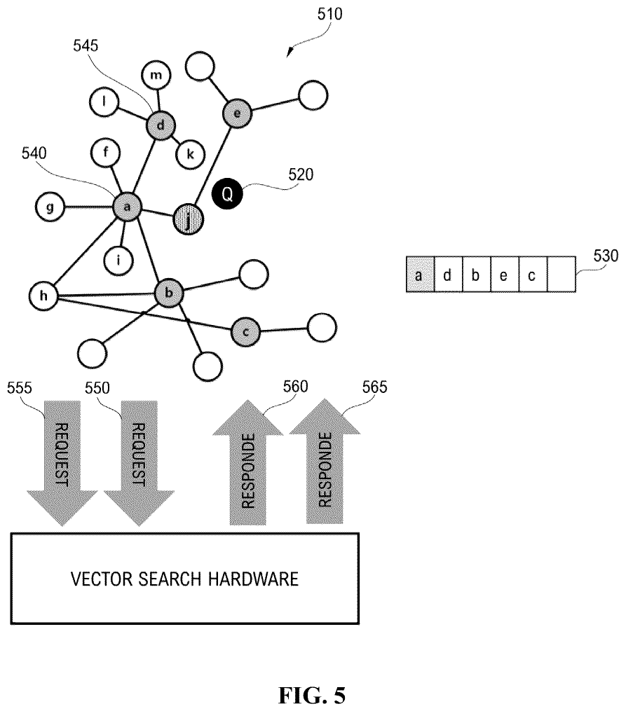

To address the issues, an embodiment of the present disclosure supports multiple vector searches in a vector database. The embodiment of the present disclosure is described below with reference to FIG. 5 and others. This embodiment of the present disclosure reduces the dependency on a vector index host of vector search hardware and increases hardware resource utilization of a vector database system.

FIG. 5 is a diagram for describing a method of requesting multiple vector search in a vector database system according to an embodiment of the present disclosure.

According to the present disclosure, when the host transmits a search request for an arbitrary query to the vector search hardware, it is possible to transmit a request for another node in the candidate list to the vector search hardware along with a request for a specific node in the candidate list (i.e., without waiting for the response to the search result). Therefore, the vector search hardware may perform a search for the specific node, return the search result to the host, and then immediately perform a search for another node without the idle time, so that it is possible to increase the hardware resource utilization

For example, in a vector data index structure such as 510, when a query such as 520 is input, the vector index host may create a candidate node list such as 530 for the query vector.

For example, when the candidate node list is a, d, b, e, and c as in 530, the vector index host may request the vector search hardware to search for the query vector Q 520 for f, g, h, i, and j, which are neighbor nodes of node a 540 with a first priority in the candidate node list as in 550. Furthermore, the host requests the vector search hardware to search for query vector Q 520 for l, m, and k, which are neighbor nodes of node d 545, which is a second priority in the candidate node list, as in 555, without waiting for a response to the request 550.

In this case, the algorithm by which the host requests multiple searches to the vector search hardware is exemplified as the search priority of the candidate node list in the above description, but the present disclosure is not limited thereto.

For example, the host may perform a scheduling process of buffering a certain number of search requests before transmitting a plurality of search requests to a vector calculator, collecting search tasks with high search target vector similarity, and then batching and requesting a search task with high vector similarity. More specifically, the host may batch and request search tasks with high Euclidean distance or cosine similarity of candidate nodes. This is because the more the neighbor nodes of the candidate nodes overlap, the higher the temporal proximity of the data points that the vector search hardware accesses in the vector search process, thereby increasing a cache hit rate.

In other words, it may be implemented by being modified into various algorithms that can increase the efficiency of the vector search. Furthermore, in the example of FIG. 5, two search requests were exemplified as multiple search requests, but the present disclosure is not limited thereto. The maximum value of multiple search requests may be based on the multiple-search counting number supported by the vector database system.

The vector search hardware that receives multiple search requests for the query Q 520 may schedule multiple vector search tasks and transmit responses to the vector search tasks to the host sequentially or in parallel, as in 560 and 565.

In this way, when the vector database system supports multiple outstanding vector requests, it is possible to increase the resource utilization of the vector search hardware. In the example of FIG. 4, the host receives the response from the vector search hardware, updates the candidate list, and then transmits the next search request to the vector search hardware, and therefore the idle time occurs in the search task execution of the vector search hardware. However, in the example of FIG. 5, since the host does not wait for the response from the vector search hardware and transmits multiple search requests, the vector search hardware only needs to schedule the search task, and there is no need for the idle time. Therefore, the idle time of the vector search hardware and the dependency of the vector search hardware on the vector index host are removed, so that it is possible to increase the efficiency of the vector database system and the utilization of the hardware resources.

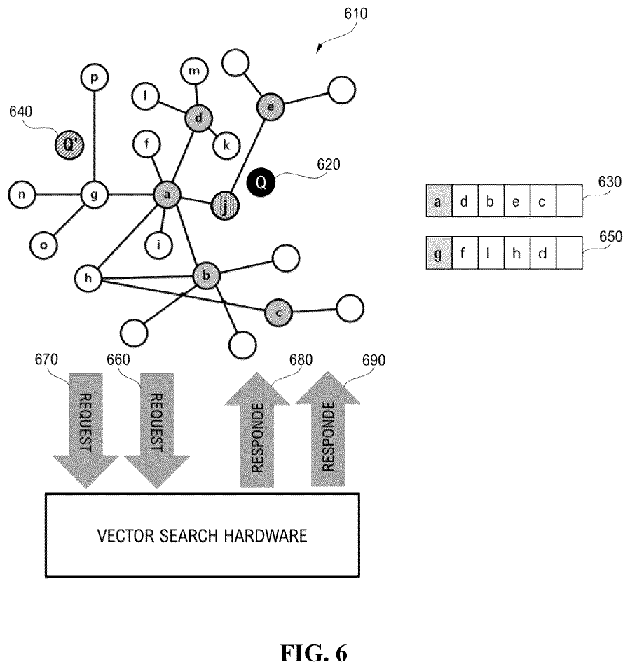

FIG. 6 is a diagram for describing a method of requesting a vector search for multiple queries in a vector database system according to an embodiment of the present disclosure.

According to another embodiment of the present disclosure, when the host transmits a search request for an arbitrary query to the vector search hardware, a search request for another query may also be transmitted together (i.e., without waiting for the response). In this case, the vector search hardware may perform a search for a specific node of a specific query, return the search result to the host, and then immediately perform a search for another node without the idle time, so that it is possible to increase the hardware resource utilization.

For example, in a vector data index structure such as 610, when a query Q such as 620 is input, the vector index host may create a candidate node list such as 630 for the query vector.

For example, when the candidate node list is a, d, b, e, and c as in 630, the vector index host may request the vector search hardware to search for a query Q 620 for f, g, h, i, and j, which are neighbor nodes of node a 540 with a first priority in the candidate node list as in 660.

Furthermore, the host may request the vector search hardware to search for another query Q′ 640, as in 670, without waiting for a response to the request 660. More specifically, the host may create a candidate node list, such as 650, for the query vector when the query Q′, such as 640, is received. For example, when the candidate node list is g, f, l, f, and d as in 650, the vector index host may request the vector search hardware to search for the query Q′ 640 for p, n, and o, which are neighbor nodes of node g with a first priority in the candidate node list as in 670.

According to an embodiment of the present disclosure, the algorithm by which the host requests multiple searches to the vector search hardware can be modified in various ways to increase the efficiency of the vector search. Furthermore, in the example of FIG. 6, the number of queries, which is multiple search targets, is exemplified as two, but the present disclosure is not limited thereto. The maximum value of multiple search requests may be based on the multiple-search counting number supported by the vector database system.

For example, the host may perform a scheduling process of buffering a certain number of search requests before transmitting a plurality of search requests to a vector calculator, collecting a search task with a high search target vector similarity, and then batching and requesting a search task with high vector similarity. More specifically, the host may batch and request search tasks with high Euclidean distance or cosine similarity of query vectors. This is because the more the neighbor nodes of the candidate nodes overlap, the higher the temporal proximity of the data points that the vector search hardware accesses in the vector search process, thereby increasing a cache hit rate.

The vector search hardware, which receives the search requests for both the query Q 620 and the query Q′ 640, may schedule multiple vector search tasks and transmit the responses to the received requests to the host sequentially or in parallel, as in 680 and 690

In this way, when the vector database system supports multiple outstanding vector requests, it is possible to increase the resource utilization of the vector search hardware. In the example of FIG. 4, the host receives the response from the vector search hardware, updates the candidate list, and then transmits the next search request to the vector search hardware, and therefore the idle time occurs in the search task execution of the vector search hardware. However, in the example of FIG. 6, as in FIG. 5, the host does not wait for the response from the vector search hardware, but transmits multiple search requests, so that the vector search hardware only needs to schedule the search task and the idle time is removed. Therefore, the idle time of the vector search hardware and the dependency of the vector search hardware on the vector index host are removed, so that it is possible to increase the efficiency of the vector database system and the utilization of the hardware resources.

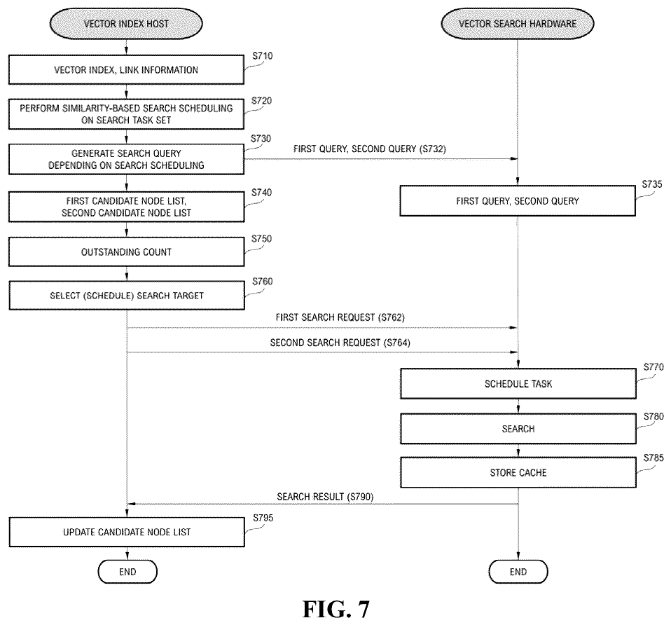

FIG. 7 is a flowchart illustrating a method for processing multiple vector searches in a vector database system, according to an embodiment of the present disclosure.

The present embodiment relates to an embodiment in which multiple searches are performed while search tasks are scheduled, such that search tasks with high access vector similarity are capable of being performed as sequentially as possible to improve a cache hit ratio.

In operation S710, a vector index host may form an index to effectively search for a high-dimensional vector dataset. Indexing may be performed in various ways, and the present disclosure should not be construed as being limited thereto. For example, the vector index host may generate a vector index by using a graph including a node representing a feature value of a data point and an edge representing the relationship between a plurality of nodes. According to an embodiment, the graph may be formed in a hierarchical structure, but is not limited thereto.

When a search task set including a plurality of search tasks is input, in operation S720, the vector index host may perform a similarity-based search scheduling task of associatively placing the search task set based on the similarity between the plurality of search tasks within the search task set.

Afterwards, in operation S730, the vector index host may sequentially generate queries for searches depending on the similarity-based search scheduling, and may provide the generated queries to the vector search hardware. FIG. 7 illustrates an example (i.e., an example of processing two queries) of providing a first query for a first search and a second query for a second search are provided from among similarity-based search scheduling (operation S732). However, an embodiment is not limited thereto, and three or more queries may be processed simultaneously.

In operation S735, the vector search hardware may store one or more query information to process different nearest neighbor search tasks, i.e., search tasks for multiple queries.

In operation S740, the vector index host may create a candidate node list for each search query. For example, the vector index host may create a first candidate node list for the first query and a second candidate node list for the second query. The candidate node list may be a list of nodes that calculate similarity between a query vector and neighboring nodes, and the size and update conditions of the candidate node list may be preset. In operation S740, the vector index host according to an embodiment of the present disclosure may create candidate node lists for one or more queries.

In operation S750, the vector index host may confirm an outstanding count. The outstanding count is the total number of search tasks being processed or waiting in the vector search hardware at that time. The vector index host may confirm the system load and spare resources by confirming the outstanding count of the vector search hardware. In this way, the vector index host can identify the number of requests that may be additionally processed by the vector search hardware at that time.

In operation S760, the vector index host may select a target to search for an arbitrary query in the vector search hardware.

For example, the vector index host may select the neighbor nodes of the first node in the first candidate node list of the first query as the search targets for the first query. Furthermore, the vector index host may select the neighbor nodes of the second node in the first candidate node list as the search targets for the first query. Thereafter, the vector index host may transmit the search requests to the vector search hardware sequentially or in parallel by referring to the number of requests that may be additionally processed by the vector search hardware determined in operation S750 (operations S762 and S764).

As another example, the vector index host may select neighbor nodes of an arbitrary node in the first candidate node list of the first query as the search targets for the first query. Furthermore, the vector index host may select neighbor nodes of an arbitrary node in the second candidate node list of the second query as the search targets for the second query. Thereafter, the vector index host may transmit the search requests to the vector search hardware sequentially or in parallel by referring to the number of requests that may be additionally processed by the vector search hardware determined in operation S750 (operations S762 and S764).

As another example, the vector index host may select the neighbor nodes of the first node in the first candidate node list of the first query as the search targets for the first query. Furthermore, the vector index host may select the neighbor nodes of the second node in the first candidate node list of the first query as the search targets for the first query. The vector index host may select neighbor nodes of a third node in the second candidate node list of the second query as the search targets for the second query. Furthermore, the vector index host may select neighbor nodes of a fourth node in the second candidate node list of the second query as the search targets for the second query. Thereafter, the vector index host may transmit the search requests to the vector search hardware sequentially or in parallel by referring to the number of requests that may be additionally processed by the vector search hardware determined in operation S750 (operations S762 and S764).

According to an embodiment of the present disclosure, in operations S760 to S764, the vector index host may perform a scheduling process of buffering a certain number of search requests before transmitting a plurality of search requests to a vector calculator, collecting a search task with a high search target vector similarity, and then batching and requesting a search task with high vector similarity.

More specifically, the vector index host may batch and request search tasks with high Euclidean distance or cosine similarity of candidate nodes, or batch and request search tasks with high Euclidean distance or cosine similarity of query vectors. This is because the more the neighbor nodes of the candidate nodes overlap, the higher the temporal proximity of the data points that the vector search hardware accesses in the vector search process, thereby increasing a cache hit rate.

The vector search hardware that receives the search request may schedule a plurality of vector search tasks in operation S770, and store the search result in the memory cache in operation S785 while performing the plurality of search tasks sequentially or in parallel in operation S780.

For example, when the vector search hardware receives a first request to perform a search for neighbor nodes of the first node for the first query and a second request to perform a search for neighbor nodes of the second node for the first query, the vector search hardware may schedule a first search task according to the first request and a second search task according to the second request, and store each search result in the memory cache while performing the first search task and the second search task sequentially or in parallel.

As another example, when the vector search hardware receives a first request to perform a search for neighbor nodes of an arbitrary node for the first query and a second request to perform a search for neighbor nodes of an arbitrary node for the second query, the vector search hardware may schedule the first search task according to the first request and the second search task according to the second request, and store each search result in the memory cache while performing the first search task and the second search task sequentially or in parallel.

When each search task is completed, the vector search hardware may transmit search results for multiple search tasks to the vector index host sequentially or in parallel in operation S790.

In operation S795, the vector index host may update the candidate node list of the corresponding query by referring to the search results.

In the embodiment illustrated in FIG. 7, since the similarity between search queries is high, the cache hit ratio stored in the vector search hardware increases, thereby resulting in significantly improved search performance. That is, in the case where the cache hit ratio is low during a search for the vector search hardware, new loading of surrounding nodes for the search occurs frequently in a memory, and thus a lot of time and resources are required for the overall task searches. However, in an embodiment of the present disclosure, since searches with similar query vectors are performed together in the search task, data of surrounding nodes stored in the vector search hardware is used as is (i.e., the cache hit ratio is increased), thereby minimizing memory loading for search comparison.

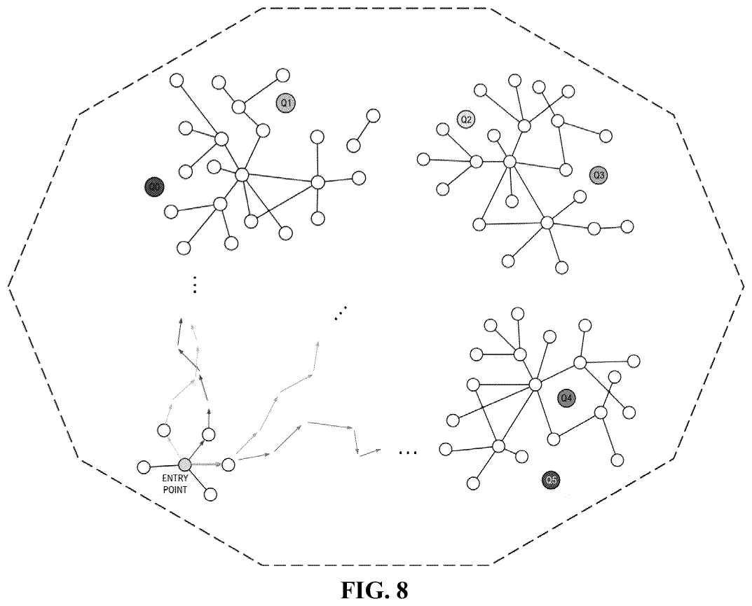

FIG. 8 is a diagram illustrating a search processing order according to search scheduling, according to an embodiment of the present disclosure.

FIG. 8 illustrates query vectors for each search represent as Q0, Q1, Q2, Q3, Q4, and Q5, and visually illustrates the placement of these query vectors to find search target nodes.

As shown in FIG. 8, when the similarity between query nodes is high, there is a high probability that nodes of performing search operations during a process of reaching a query node from an entry node overlap each other.

That is, assuming that a vector calculator simultaneously supports two query search tasks, the vector index host may schedule and process the query search tasks based on the similarity between search vectors, such as (Q0, Q1), (Q2, Q3), and (Q4, Q5), rather than randomly processing the query search tasks. In this way, the possibility of overlapping nodes performing search operations in the process of reaching the query node from the entry node may be increased, thereby improving the hit ratio of the vector cache.

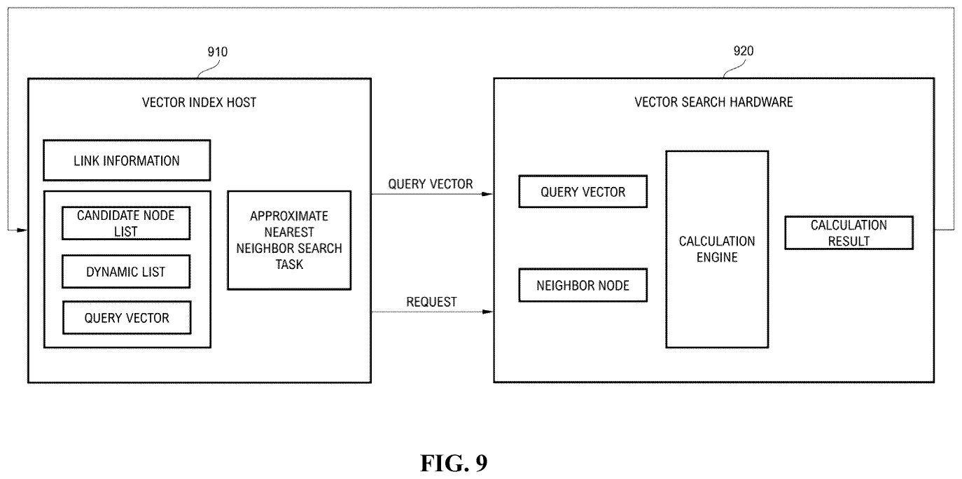

FIG. 9 is a diagram for describing a structure of a vector database system in which dependency of a vector search processing engine on a vector index host occurs.

In the vector database system of FIG. 9, the vector index host 910 is a software system component running on the CPU that processes the operation of the ANN algorithm. The vector search hardware 920 is a hardware device that accelerates the vector and matrix operations, and may be called dedicated hardware or an offloading engine that is in charge of the vector calculation in the vector database system.

When a query is input to an arbitrary vector index structure, the vector index host 910 may create the candidate node list for the query vector, extract an arbitrary node from the candidate node list, and generate an approximate nearest neighbor search task that searches for neighbor nodes of the extracted node by referring to the link information. Thereafter, the vector index host 910 may transmit the request requesting the query search for the search target to the vector search hardware 920 along with the information of the query vector or sequentially.

The vector search hardware 920 receives the request from the vector index host 910 to perform the search task, returns the search task to the vector index host 910, and maintains the idle state until the next request is received.

Thereafter, the vector index host 910 receives the response from the vector search hardware 920, updates the candidate node list, and then transmits the next search request to the vector search hardware 920. After receiving the search request from the vector index host 910, the vector search hardware 920 terminates the idle state and performs the search task again.

In the example of FIG. 9, the operation of the vector search hardware 920 is dependent on the vector index host 910, and causes the idle time in the performance of the search task.

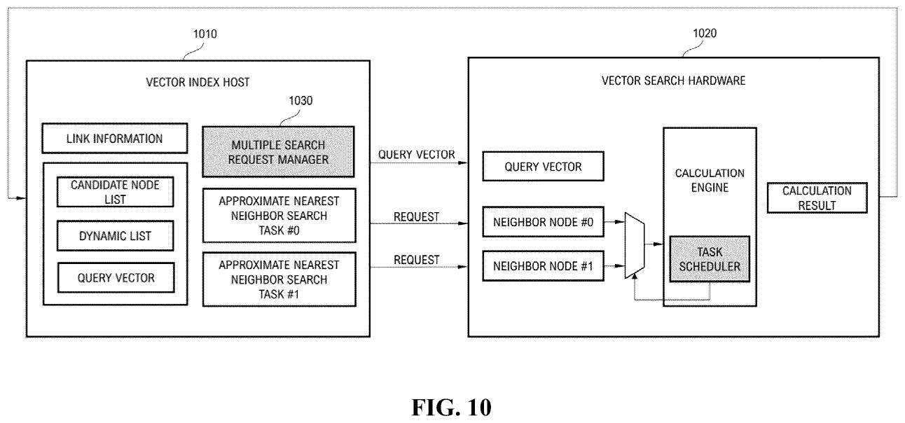

FIG. 10 is a diagram for describing the structure of the vector database system for processing multiple vector search requests according to an embodiment of the present disclosure.

In the example of FIG. 10, when a query is input to any vector index structure, the vector index host 1010 may create the candidate node list for the query vector.

In particular, the vector index host 1010 according to an embodiment of the present disclosure includes a multiple search request manager 1030 module. The multiple search request manager 1030 may confirm the outstanding count of the vector search hardware 1020 to identify the number of requests that may be additionally processed by the vector search hardware 920 at that time.

Furthermore, the vector index host 1010 may generate a search task to be requested from the vector search hardware 1020.

For example, the vector index host 1010 may select the neighbor nodes of the first node of the candidate node list of the corresponding query as search targets for the corresponding query and generate approximate nearest neighbor search task #0. Furthermore, the vector index host 1010 may select the neighbor nodes of the second node of the candidate node list of the corresponding query as the search targets for the corresponding query and generate approximate nearest neighbor search task #1. Thereafter, the vector index host 1010 can transmit the search request to the vector search hardware 1020 sequentially or in parallel by referring to the number of requests that may be additionally processed by the vector search hardware 1020 determined by the multiple search request manager 1030.

The vector search hardware 1020, which receives the search request, may schedule a plurality of vector search tasks through a task scheduler included in a calculation engine, and store the search results in the memory cache while performing the plurality of search tasks sequentially or in parallel.

In the above example, when the vector search hardware 1020 receives a first request to perform a search for neighbor nodes of the first node for the query and a second request to perform a search for neighbor nodes of the second node for the corresponding query, the vector search hardware 1020 may schedule the first search task according to the first request and the second search task according to the second request, and store each search result in the memory cache while performing the first search task and the second search task sequentially or in parallel.

When each search task is completed, the vector search hardware 1020 may transmit the search results for the plurality of search tasks to the vector index host 1010 sequentially or in parallel, and the vector index host 1010 may update the candidate node list by referring to the search results.

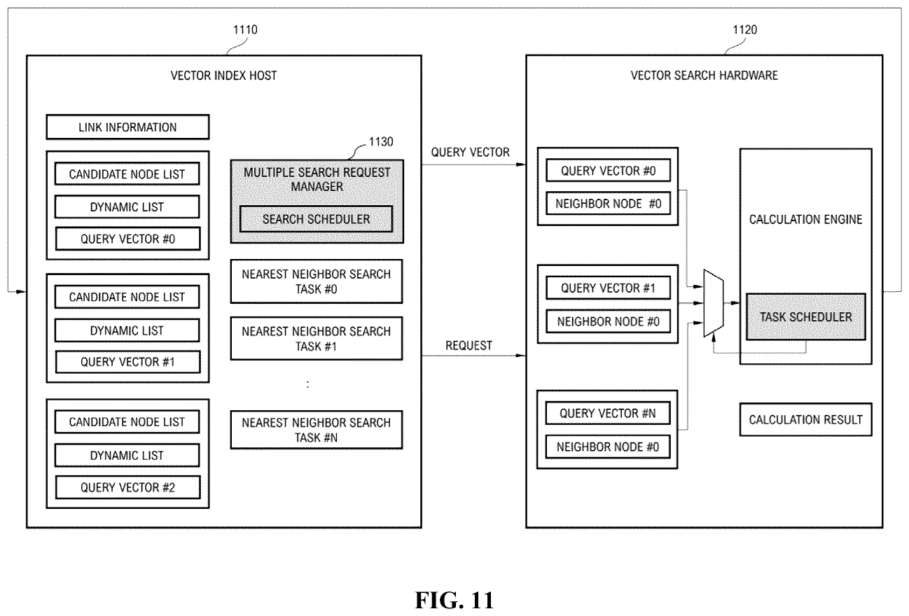

FIG. 11 is a diagram for describing a structure of a vector database system that processes a vector search request for a plurality of queries, according to an embodiment of the present disclosure.

In the example of FIG. 11, a vector index host 1110 may receive a search task for an arbitrary vector index structure. At this time, this input may be a set of search tasks including a plurality of search tasks.

The vector index host 1110 generates a query vector corresponding to each of the plurality of search tasks included in the search task set and may create a candidate node list for each query vector. In the meantime, when querying vector search hardware 1120 with query vectors corresponding to each of the plurality of search tasks, the vector index host 1110 may perform a similarity-based search scheduling task of determining the query order for the plurality of search tasks, such that queries proceeds based on the similarity between query vectors.

As shown in FIG. 11, the vector index host 1110 includes a multi-search request manager 1130. The multi-search request manager 1130 may include a search scheduler.

When the multi-search request manager 1130 receives a search task set including a plurality of search tasks, the search scheduler may perform a similarity-based search scheduling task that associates the search task set based on the similarity between the plurality of search tasks included in the search task set.

The search scheduler may buffer a certain amount of search requests before transmitting the plurality of search requests to a vector calculator and may perform a task of collecting a search task with high access vector similarity.

In an embodiment, the number of search requests buffered by the search scheduler may be a multiple of the number of query vector processing tasks of the vector search hardware 1120. In the example of FIG. 11, the vector search hardware 1120 is illustrated to have three query vector processing tasks. For example, the search scheduler may perform similarity-based search scheduling by determining access vector similarity for six search requests. In this case, multiple search tasks and similarity are simultaneously satisfied and performed, thereby improving the cache hit ratio and parallel processing efficiency such that a vector search is possible with optimal efficiency.

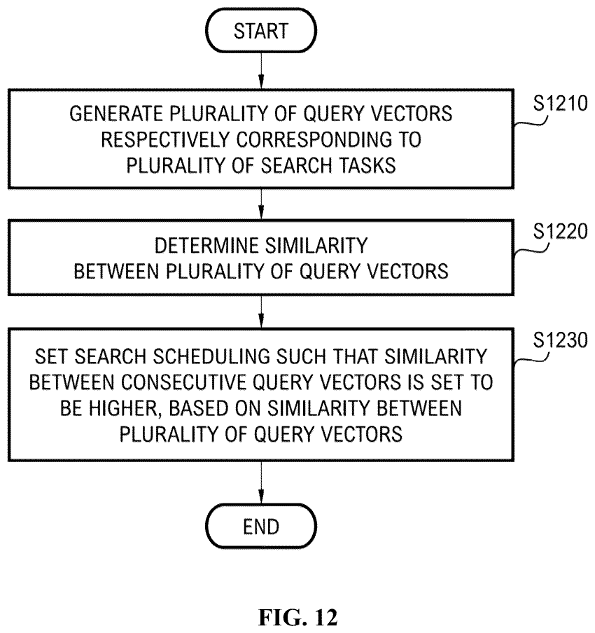

The similarity-based search scheduling task may be implemented in various ways. For example, various methods are possible, such as a method of directly determining similarity between query vectors to determine scheduling, as well as a method of indirectly inferring the similarity to determine scheduling. A more detailed description of this will be given below with reference to FIGS. 12 to 14.

After the similarity-based search scheduling task, the multi-search request manager 1130 checks the outstanding count of the vector search hardware 1120 to identify the number of requests capable of being additionally processed by the vector search hardware 1120 at the corresponding time. Furthermore, the vector index host 1110 may generate a search task to be requested from the vector search hardware 1120.

For example, the vector index host 1110 may select neighboring nodes of any node in the candidate node list of a first query as search targets for the first query. Furthermore, the vector index host 1110 may select neighboring nodes of any node in the candidate node list of a second query as search targets for the second query. Afterwards, the vector index host 1110 may, sequentially or in parallel, deliver search requests to the vector search hardware 1120 with reference to the number of requests, which the vector search hardware 1120 is capable of additionally processing, and which are determined by the multi-search request manager 1130.

The vector search hardware 1120, which receives the search request, may schedule a plurality of vector search tasks through a task scheduler included in a calculation engine, and store the search results in the memory cache while performing the plurality of search tasks sequentially or in parallel.

In the above example, when the vector search hardware 1120 receives a first request to perform a search for neighbor nodes of an arbitrary node for the first query and a second request to perform a search for neighbor nodes of an arbitrary node for the second query, the vector search hardware 1120 may schedule the first search task according to the first request and the second search task according to the second request, and store each search result in the memory cache while performing the first search task and the second search task sequentially or in parallel.

When each search task is completed, the vector search hardware 1120 may transmit the search results for the plurality of search tasks to the vector index host 1110 sequentially or in parallel, and the vector index host 1110 may update the candidate node lists by referring to the search results.

In the examples of FIG. 11, the vector index host 1110 does not wait for the response of the vector search hardware 1120, but transmits multiple search requests, so that the vector search hardware 1120 only needs to schedule the search task and the idle time does not occur. Therefore, the idle time of the vector search hardware and the dependency of the vector search hardware 1120 on the vector index host 1110 are removed, so that it is possible to increase the efficiency of the vector database system and the utilization of the hardware resources.

The multi-search request manager 1130 including the search scheduler is described above with reference to FIG. 11, but it is not limited to the embodiment illustrated in FIG. 11. That is, it will be readily understood from the above description that the search scheduler is capable of being applied to the multi-search request manager 1030 illustrated in FIG. 10.

FIG. 12 is a flowchart illustrating an embodiment of a similarity-based search scheduling task, which is set based on similarity between search tasks, according to an embodiment of the present disclosure.

An embodiment of the similarity-based search scheduling task of FIG. 12 may be performed by a search scheduler.

The search scheduler may generate a plurality of query vectors respectively corresponding to a plurality of search tasks (S1210).

The search scheduler may determine the similarity between the plurality of query vectors (S1220) and may set search scheduling such that similarity between consecutive query vectors is set to be higher than similarity between non-consecutive query vectors, based on the similarity between the plurality of query vectors (S1230).

For example, when measuring access vector similarity between search tasks belonging to the same nearest neighbor search task, it may determine that the access vector similarity is high when a Euclidean distance or cosine similarity of a candidate node is high. The reason is that the possibility that neighboring nodes overlap each other is high, as the similarity between nodes is high.

For example, the plurality of search requests may belong to a nearest neighbor search task, which is a candidate node for finding the same query vector. Alternatively, the plurality of search requests may belong to different nearest-neighbor search tasks, which are candidate nodes for finding different query vectors.

For example, when measuring access vector similarity between search tasks belonging to different nearest neighbor search tasks, it may determine that the access vector similarity of a search task is high when the Euclidean distance of query vectors targeted by search tasks is close or the cosine similarity is high. The reason is that as the similarity between query vectors is high, the degree, to which access vectors overlap each other during a process of traversing the nearest vector from the entry point, is high.

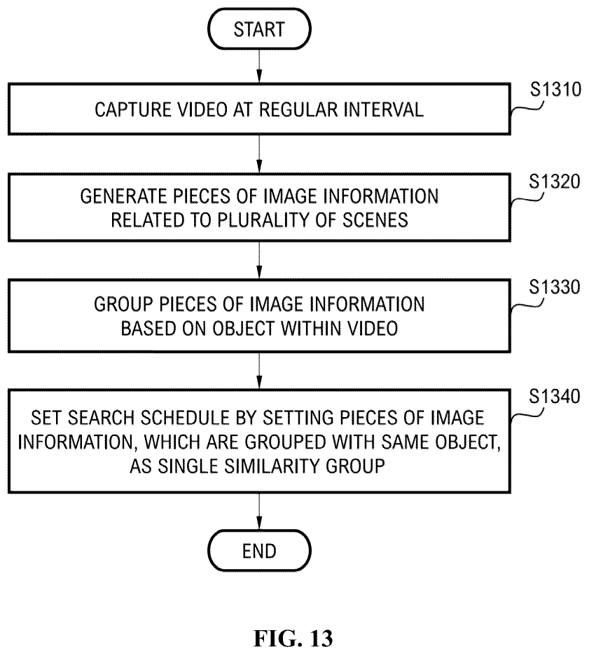

FIG. 13 is a flowchart illustrating an embodiment of a similarity-based search scheduling task, which is set based on similarity between search tasks, according to another embodiment of the present disclosure.

In this embodiment, a search task set may be pieces of image information related to a plurality of scenes generated by capturing a video at regular intervals.

For example, the image information may be a scene, i.e., a frame image itself, or image information for a specific object identified within the image. Various configurations are possible.

The search scheduler may capture a video at regular intervals (S1310) and may generate pieces of image information related to a plurality of scenes (S1320).

The search scheduler may group the pieces of image information based on objects within the video (S1330).

The search scheduler may set a search schedule by setting the pieces of image information, which are grouped with the same object, as a single similarity group (S1340).

In the meantime, the embodiments illustrated in FIGS. 12 and 13 are described individually. However, the search scheduler may also perform these embodiments simultaneously and in combination. For example, when the number of candidate nodes belonging to the nearest neighbor search task is less than the number capable of being requested, it may perform scheduling by selecting an appropriate embodiment in consideration of this.

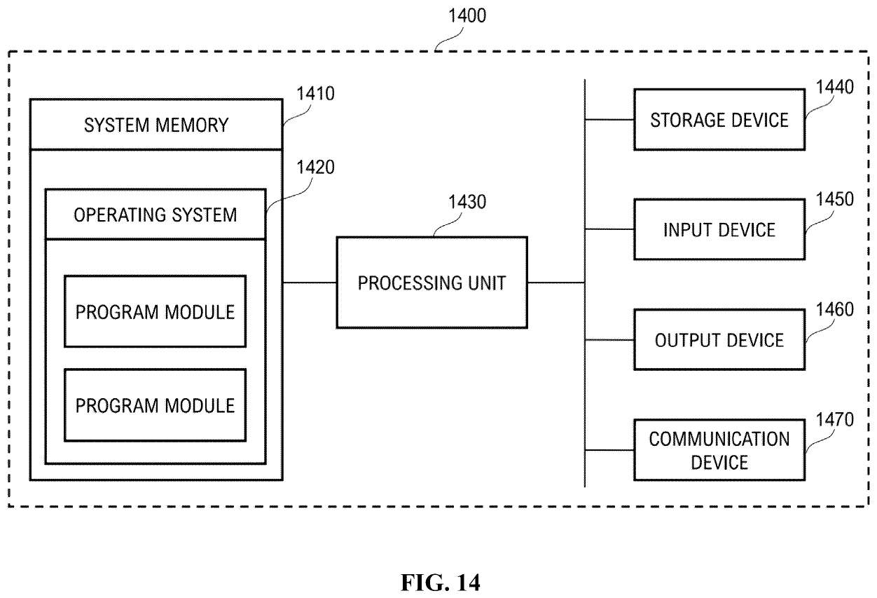

FIG. 14 is a diagram for describing a computing operating environment of a vector index host, according to one embodiment of the present disclosure.

FIG. 14 is designed to provide a general and simplified description of a suitable computing environment in which embodiments of a vector index host are capable of being implemented. Referring to FIG. 14, a computing apparatus 1400 is illustrated as an example of a vector index host.

The computing device may include at least a processing unit 1430 and a system memory 1410.

The computing device 1400 may also include a plurality of processing units that cooperate in executing a program. Depending on the exact configuration and type of the computing device, a system memory 1410 may be volatile (e.g., RAM), nonvolatile (e.g., ROM, flash memory, etc.), or a combination thereof. The system memory 1410 includes a suitable operating system 1420 for controlling the operation of the platform, such as the WINDOWS operating system from Microsoft Corporation. The system memory 1410 may also include one or more software applications, such as program modules, applications, etc.

The computing device 1400 may include additional data storage devices 1440, such as magnetic disks, optical discs, or tapes. Such additional storage may be removable storage and/or fixed storage. Computer-readable storage media may include volatile and nonvolatile, removable and fixed media implemented in any method or technique for storing information such as computer-readable instructions, data structures, program modules, or other data. The system memory 1410 and the storage 1440 are all examples of computer-readable storage media. The computer-readable storage media may include, but are not limited to, a RAM, a ROM, an EEPROM, a flash memory or other memory technology, a CD-ROM, a DVD or other optical storage, magnetic tape, magnetic disk storage or other magnetic storage devices, or any other medium capable of storing desired information and being accessed by the computing device 1400.

An input device 1450 of the computing device 1400 may include, for example, a keyboard, a mouse, a pen, a voice input device, a touch input device, and comparable input devices. The input device 1450 is widely known in the art, so a detailed description is omitted.

An output device 1460 of the computing device may include, for example, a display, a speaker, a printer, and other types of output devices. These output devices 1460 are well known in the art and therefore a detailed description thereof will be omitted.

The computing device 1400 may also include a communication device 1470 that allows the device to communicate with other devices via a network, such as a wired or wireless network, a satellite link, a cellular link, a local area network, and comparable mechanisms in a distributed computing environment. The communication device 1470 is one example of a communication medium, which may include computer-readable instructions, data structures, program modules, or other data therein. By way of example only, the communication medium may include, but is not limited to, wired media, such as a wired network or direct connection, and wireless media, such as acoustic, RF, infrared, and other wireless media.

Methods according to various embodiments of the present application may be implemented in the form of program commands that may be executed through various computer means and may be recorded in a computer-readable recording medium. The computer-readable recording medium may include program commands, data files, data structures or the like, alone or in combination. The program commands recorded in the computer-readable recording medium may be specially designed and configured for the embodiments or be known to those skilled in the field of computer software. Examples of the computer-readable recording medium may include a magnetic medium such as a hard disk, a floppy disk, or a magnetic tape; an optical medium such as a CD-ROM or a DVD; a magneto-optical medium such as a floptical disk; and a hardware device specially configured to store and execute program commands, such as a ROM, a RAM, a flash memory, or the like. Examples of the program commands may include machine language codes such as those made by compilers as well as high-level language codes capable of being executed by computers using interpreters or the like. The above-described hardware device may be constituted to be operated as one or more software modules to perform the operations of the embodiments, and vice versa.

According to an embodiment of the present disclosure, a cache hit ratio may be improved by scheduling search tasks such that search operations with high access vector similarity are capable of being performed as sequentially as possible. Furthermore, the execution speed of a task may be improved by reducing memory access time by reusing information stored in a cache when multiple query vectors are sequentially processed through it.

According to an embodiment of the present disclosure, the efficiency of a task accessing the vector closest to a query vector may be improved by increasing a caching hit ratio. Accordingly, the execution speed of a task may be improved by reducing memory access time by reusing information stored in a cache. Moreover, by optimizing caching based on the similarity between vectors, unnecessary memory access may be prevented and memory resources may be efficiently utilized during task execution.

According to an embodiment of the present disclosure, a high caching hit ratio may reduce the time required to search data in a memory, thereby improving the speed of search tasks in large datasets and providing faster response times. As a result, users may obtain desired results more quickly and system latency may be minimized.

According to an embodiment of the present disclosure, increasing the cache hit ratio may be a method of efficiently utilizing resources within a vector calculator. By utilizing information stored in a cache, memory access time may be minimized and resources required for vector operations may be optimized. Besides, when search tasks are scheduled in consideration of the similarity between vectors, the processing capability of a vector calculator may be utilized maximally.

According to an embodiment of the present disclosure, most of the tasks processed by the vector calculator may fetch data from the cache by increasing the caching hit ratio, thereby reducing the time when the calculator remains idle. In this way, throughput may be increased by maximizing the use of the vector calculator's resources, and the overall performance of the system may be improved.

According to an embodiment of the present disclosure, the idle time of a hardware engine that processes vector searches may be reduced, thereby increasing the efficiency of the vector database system. Furthermore, according to an embodiment of the present disclosure, the dependency of vector search hardware on the vector database host may be removed, thereby increasing hardware resource utilization of the vector database system.

Effects of the present disclosure are not limited to the above-described effects, and any other effects not mentioned herein may be clearly understood from this specification and the accompanying drawings by those skilled in the art to which the present disclosure pertains.

Embodiments have been described hereinabove by restrictive examples and drawings, but various modifications and variations may be made from the above description by those skilled in the art. For example, even when the described technologies are performed in an order different from that of the described method and/or components of the described system, structure, device, circuit, and the like, are coupled to or combined with each other in a form different from that of the described method, or are replaced by other components or their equivalents, appropriate results may be achieved.

Therefore, other implementations, other embodiments, and equivalents of the claims are within the scope of the following claims.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. A method for processing multiple vector searches using similarity-based search scheduling in a vector search system, the method comprising:
receiving, by an apparatus executing a vector index host, a search task set including a plurality of search tasks;
associatively performing, by the apparatus executing the vector index host, a similarity-based search scheduling task based on similarity between the plurality of search tasks included in the search task set;
performing, by the apparatus executing the vector index host, a search request by delivering, in an order of the similarity-based search scheduling task, a query vector corresponding to each of the plurality of search tasks to an apparatus executing a vector search; and
delivering, by the apparatus executing the vector search, a search result for the search request to the apparatus executing the vector index host,
wherein the performing of the similarity-based search scheduling task includes:
generating a plurality of query vectors respectively corresponding to the plurality of search tasks;
determining similarity between the plurality of query vectors; and
setting search scheduling such that similarity between consecutive query vectors in a search scheduling order is set to be higher than similarity between non-consecutive query vectors in the search scheduling order, based on the similarity between the plurality of query vectors.

2. The method of claim 1, wherein the search task set is pieces of image information related to a plurality of scenes generated by capturing a video at a regular interval, and
wherein the performing of the similarity-based search scheduling task includes:
grouping the pieces of image information based on an object in the video; and
setting a search schedule by setting the pieces of image information, which are grouped with a same object, as a single similarity group.

3. The method of claim 1, wherein the performing of the search request by delivering the query vector corresponding to each of the plurality of search tasks to the apparatus executing the vector search includes:
delivering, by the apparatus executing the vector index host, each query corresponding to each search task to the apparatus for executing the vector search in an order of the similarity-based search scheduling task; and
creating, by the apparatus executing the vector index host, a candidate node list for searching for the query with respect to the respective query.

4. The method of claim 3, wherein the performing of the search request by delivering the query vector corresponding to each of the plurality of search tasks to the apparatus executing the vector search further includes:
checking, by the apparatus executing the vector index host, a multi-search count;
selecting at least one search target node from the candidate node list; and
delivering a search request for a neighboring node of the node to the apparatus for executing the vector search.

5. The method of claim 4, wherein the performing of the search request by delivering the query vector corresponding to each of the plurality of search tasks to the apparatus executing the vector search includes:
delivering, by the apparatus executing the vector index host, a first search request for searching for similarity with the query with respect to a neighboring node of a first node of the candidate node list for searching for an arbitrary query; and
delivering, by the apparatus executing the vector index host, a second search request for searching for similarity with the query with respect to a neighboring node of a second node of the candidate node list without waiting for a response to the first search request.

6. A vector search system that supports multiple vector searches, the vector search system comprising:
an apparatus executing a vector index host configured to:
receive a search task set including a plurality of search tasks;
associatively perform a similarity-based search scheduling task based on similarity between the plurality of search tasks included in the search task set; and
perform a search request by delivering, in an order of the similarity-based search scheduling task, a query vector corresponding to each search task to an apparatus executing a vector search; and
the apparatus executing the vector search configured to:
deliver a search result for the search request to the apparatus executing the vector index host, and
wherein the apparatus executing the vector index host configured to:
generate a plurality of query vectors respectively corresponding to the plurality of search tasks;
determine similarity between the plurality of query vectors; and
set search scheduling such that similarity between consecutive query vectors in a search scheduling order is set to be higher than similarity between non-consecutive query vectors in the search scheduling order, based on the similarity between the plurality of query vectors.

7. The vector search system of claim 6, wherein the search task set is pieces of image information related to a plurality of scenes generated by capturing a video at a regular interval, and
wherein the apparatus executing the vector index host is configured to:
group the pieces of image information based on an object in the video; and
set a search schedule by setting the pieces of image information, which are grouped with a same object, as a single similarity group.

8. A computer-readable storage medium storing instructions that, when executed by a computer apparatus, cause the computer apparatus to:
receive a search task set including a plurality of search tasks;
associatively perform a similarity-based search scheduling task based on similarity between the plurality of search tasks included in the search task set;
perform a search request by delivering, in an order of the similarity-based search scheduling task, each query vector corresponding to each search task to an apparatus executing a vector search; and
wherein the performing of the similarity-based search scheduling task includes:
generating a plurality of query vectors respectively corresponding to the plurality of search tasks;
determining similarity between the plurality of query vectors; and
setting search schedule such that similarity between consecutive query vectors in a search scheduling order is set to be higher than similarity between non-consecutive query vectors in the search scheduling order, based on the similarity between the plurality of query vectors.
